(19) United States
(12) Patent Application Publication
(10) Pub. No.: US 2004/0019495 A1
(43) Pub. Date: Jan. 29, 2004

(54) System for setting up a point-of-sale system, a method for setting up a point-of-sale system, and a data recording medium storing the same

(76) Inventor: Kazuko Fukano, Matsumoto-shi (JP)

Correspondence Address: EPSON RESEARCH AND DEVELOPMENT INC, INTELLECTUAL PROPERTY DEPT, 150 RIVER OAKS PARKWAY, SUITE 225, SAN JOSE, CA, 95134, US

(21) Appl. No.: 10/390,998

(22) Filed: Mar. 18, 2003

(30) Foreign Application Priority Data
Mar. 18, 2002 (JP) 2002-074898

(51) Int. Cl. G06F 17/60

(52) U.S. Cl. 705/1

(57) ABSTRACT

A POS system setup system and method to easily execute a POS system configuration process by sending test print data compiled as a character string of necessary printer information to a host computer. A data storage medium records the setup method in computer-readable form. A query reception unit 331 of a printer 112 receives a test print request for acquiring printer information. A test print data generator 304 gets the information needed for the test print data based on the test print request received by the query reception unit 331, and generates test print data for printing the acquired printer information to paper a character string. A test print destination detector 305 determines the destination of the test print data generated by the test print data generator 304. The test print output unit 332 outputs the test print data to the destination identified by the test print destination detector 305.

### BACKGROUND OF THE INVENTION

1. Field of the Invention

The present invention relates generally to a system and a method for setting up a point-of-sale (POS) system, and to a data recording medium for storing the same. The invention relates more particularly to a system and a method for configuring a POS system, and a data recording medium storing a POS system configuration method, whereby a POS system setup process can be easily executed by sending test print data to a host computer where the test print data is a character string of information describing a printer used in a POS terminal system.

2. Description of the Related Art

A POS system typically has a POS server, database, and multiple POS terminal systems connected via a LAN or other network. Each POS terminal system typically has a host computer, printer, display, and cash drawer. In a typical POS terminal system a particular function of the POS application changes various settings of the POS terminal system based on printer information relating to the printer's specifications and capabilities. This printer information can vary from printer to printer and includes, for example, the printer serial number, firmware version, printer switches, and the character set resident in the printer.

POS printers have therefore conventionally had a test print function for printing this printer information. The operator prints a hard copy of the printer information using this text print function and then refers to the printed printer information to enter the required settings (information) in a particular function of the POS application run by the POS terminal system.

A specific application function of the POS terminal system application may also query the printer to get specific printer information required by the specific terminal application. For example, if the specific application function requires information about the firmware version of the printer and resident character set, it may output a separate get command for each bit of needed information, such as separately outputting a get-version command and a get-character-set command.

Once the operator transfers the required printer information from the paper on which the printer information is printed to the particular function of the POS terminal system, the paper is no longer needed. The obvious problem here is that this is a waste of paper and ink.

Another problem is that entry errors can occur because the operator enters the required information while reading the printer information from the paper.

Additionally, a problem related to the above mentioned specific application function needing to request information by sending a get query to the printer, is that the printer and host computer must be able to interpret commands for each data request. Printer and host functions thus become more complex.

Furthermore, if printing is not possible when a test print request is sent to the printer because the printer is out of paper or ink, for example, the printer is left in a standby state and is unable to respond to the request until the problem is resolved.

### OBJECTS OF THE INVENTION

The present invention is therefore directed to solving these problems, and an object of this invention is to provide a setup system and setup method for a POS system, and a data recording medium storing the same, whereby a POS system setup process can be easily executed by sending test print data to a host computer where the test print data is a character string of printing information printed by the printer of a POS terminal system.

### SUMMARY OF THE INVENTION

Having extensively researched solutions to the problems of the prior art described above, we discovered that a POS system can be configured for operation by providing a printer of a POS terminal system with a function for sending to a host computer test print data that is a character string of information about the printer, and providing the host computer with a function for interpreting the test print data received from the printer and reporting required printer information contained in the test print data to a particular application function.

The invention we derived from this research is described briefly below.

A first aspect of a setup system for a POS system according to the present invention configures a POS terminal system having a host computer and a printer by setting particular information for a specific processing function of the host computer based on printer information that may be different in each printer.

The printer includes a request reception unit, a test print data generating unit, a test print destination detection unit, and a test print data output unit. The request reception unit receives a test print request for acquiring printer information from the printer. The test print data generating unit gets the requested printer information based on the test print request received by the request reception unit, and generates test print data for printing the printer information. The test print destination detection unit determines whether to output the test print data, which is a character string, to the host computer and/or to the printing mechanism of the printer based on the test print request and/or conditions pre-stored in memory. The test print data output unit outputs the test print data to the host computer or printing mechanism as determined by the test print destination detection unit.

The host computer includes a reception unit and test print data interpreting unit. The reception unit receives test print data from the printer, and the test print data interpreting unit interprets the character string in the test print data received by the reception unit, and passes particular information in the interpreted test print data to a specific processing function for configuring the POS system.

Preferably, the host computer also has a test print request command generator for generating command transmission data for the test print request based on parameters received from the specific processing function when the process request from the specific processing function to the printer is a test print request, and a transmission unit for sending the command transmission data generated by the test print request command generator to the printer.

Further preferably, the request reception unit of the printer has a host-request receiving unit for receiving print requests from the host computer, a command interpreting unit for determining if a print request received by the host-request receiving unit is a test print request, and an input operation interpreting unit for detecting test print requests from among preset print requests sent to the printer based on information input by means of an input device disposed to the printer and/or sensor status data.

Yet further preferably, the test print data output unit has a host communication unit and a printing mechanism output unit. The host communication unit generates test print transmission data for sending the test print data to the host computer, and sends the test print transmission data to the host computer. The printing mechanism output unit sends a test print data print request to the printing mechanism.

Yet further preferably, the test print destination detection unit comprises a function unit for determining output of the test print data to the host computer and/or printing mechanism based on the reception status of the host computer when output to the host computer is determined, and based on printing control of the printing mechanism when output to the printing mechanism is determined.

A POS system setup method according to the present invention for configuring a POS terminal system including a printer and a host computer sets particular information for a specific processing function of the host computer based on printer information that may be different in each of multiple printers.

The printer has (a) a request reception step for receiving a test print request for acquiring printer information from the printer, (b) a test print data generating step, (c) a test print destination detection step, and (d) a test print data output step. The (b) test print data generating step gets the requested printer information based on the test print request received by the request reception step, and generates test print data for printing the printer information. The (c) test print destination detection step determines whether to output the test print data, which is a character string, to the host computer and/or to the printing mechanism of the printer based on the test print request and/or conditions pre-stored in memory. The (d) test print data output step outputs the test print data to the host computer or printing mechanism as determined by the test print destination detection step.

The host computer has a (e) reception step for receiving test print data from the printer, and (f) a test print data interpreting step for interpreting the character string in the test print data received by the reception step, and passing particular information in the interpreted test print data to a specific processing function for configuring the POS system.

Preferably, before printer step (a) the host computer also has (g) a test print request command generating step and (h) a transmission step. The (g) test print request command generating step generates command transmission data for the test print request based on parameters received from the specific processing function when the process request from the specific processing function to the printer is a test print request. The (h) a transmission step sends the command transmission data generated by the test print request command generating step to the printer.

Yet further preferably, the (a) request reception step of the printer has (a1) a host-request receiving step for receiving print requests from the host computer, (a2) a command interpreting step for determining if a print request received by the host-request receiving step is a test print request, and (a3) an input operation interpreting step for detecting test print requests from among preset print requests sent to the printer based on information input by means of an input device disposed to the printer and/or sensor status data.

Yet further preferably, the (d) test print data output step has (d1) a host communication step for generating test print transmission data for sending the test print data to the host computer, and sending the test print transmission data to the host computer, and (d2) a printing mechanism output step for sending a test print data print request to the printing mechanism.

Yet further preferably, the (c) test print destination detection step has (c1) a step for determining output of the test print data to the host computer and/or printing mechanism based on the reception status of the host computer when output to the host computer is determined, and based on printing control of the printing mechanism when output to the printing mechanism is determined.

A first aspect of a program according to the present invention is a program for executing the steps in one of the above POS system setup methods.

A first aspect of a data recording medium according to the present invention is a computer-readable storage medium recording a program for executing the steps in one of the above POS system setup methods.

Other objects and attainments together with a fuller understanding of the invention will become apparent and appreciated by referring to the following description and claims taken in conjunction with the accompanying drawings.

### BRIEF DESCRIPTION OF THE DRAWINGS

FIG. 1 is a block diagram showing the configuration of a POS system.

FIG. 2 is a schematic diagram of a printer.

FIG. 3 shows an example of the function block configuration of a setup system for a POS system according to a preferred embodiment of the invention.

FIG. 4 is a flow chart of setup system operation.

FIG. 5 is a flow chart of printer operation in the setup system of the invention.

FIG. 6 is a flow chart showing a process whereby the host computer transmits to the printer in the setup system of the invention.

FIG. 7 is a flow chart showing how the host computer handles receiving from the printer in the setup system of the invention.

FIG. 8 shows a sample printout of the printer status information.

FIG. 9 shows a sample printout of a rolling pattern test print.

FIG. 10 shows a sample printout of maintenance data.

### DESCRIPTION OF THE PREFERRED EMBODIMENTS

A preferred embodiment of the present invention is described below with reference to the accompanying figures. It will be noted that the following embodiments are shown by way of description only and shall not limit the scope of the invention. It will be obvious to one with ordinary skill in the related art that alternative embodiments can be achieved by replacing some or all of the elements described below with equivalent elements, and all such variations are included in the scope of this invention.

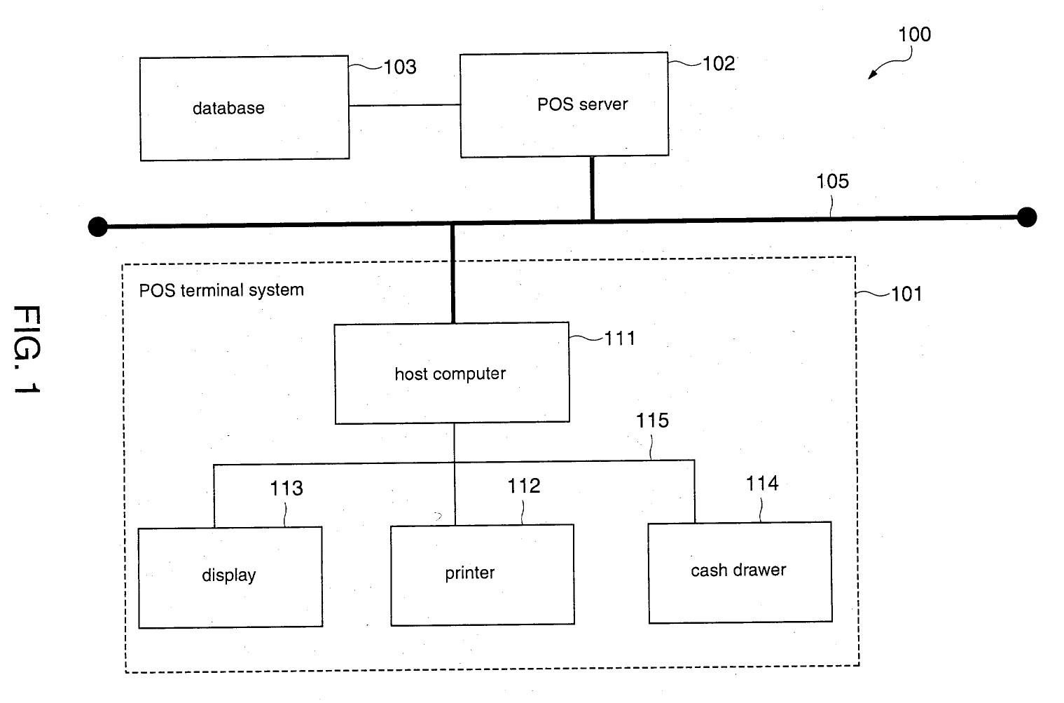

FIG. 1 is a block diagram showing the configuration of a POS system in accord with the present invention.

As shown in FIG. 1 this POS system 100 has a POS terminal system 101 for running processes such as issuing receipts, and a POS server 102 for managing the POS system, receiving buyer information and purchased product information (such as the product name) from the POS terminal system 101, and sending information such as customer information for the buyer, price information for the purchased products, and product discount information to the POS terminal system 101. The POS terminal system 101 and POS server 102 are connected via a LAN or other network 105. The POS system 100 also has a database 103 for storing information managed by the POS server 102. The database 103 could be connected to the POS server 102 or connected to the network 105.

The POS terminal system 101 has a host computer 111, printer 112, display 113, and cash drawer 114. The host computer 111 stores an application program that provides the various functions of the POS terminal system 101. The host computer 111 is also connected via respective communications lines 115 to a printer 112 for printing receipts and a sales journal, for example; a display 113 for displaying information about purchased products, for example; and a cash drawer 114 for holding and dispensing cash and other payment instruments. Various communication protocols can be used on the communications lines 115 according to the preferred communication format, i.e., serial cable, parallel cable, network cable, USB (Universal Serial Bus), or other.

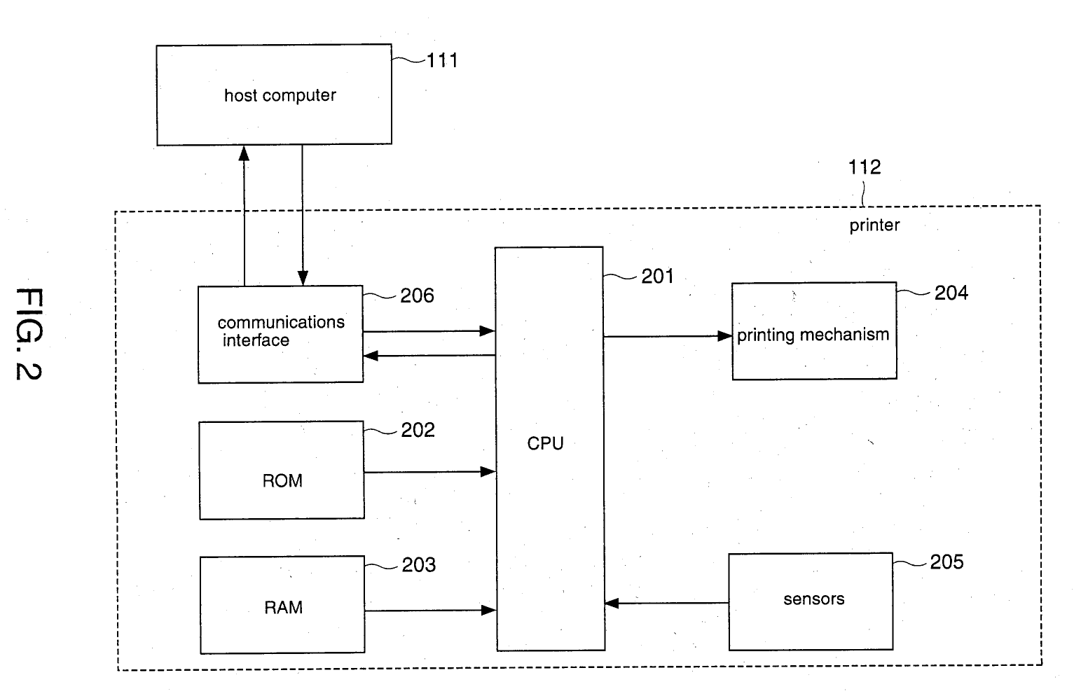

FIG. 2 is a schematic diagram of the printer.

The printer 112 receives commands, command data, and print data from the host computer 111 through a communications interface 206. The printer 112 also has a CPU 201, ROM 202, RAM 203, printing mechanism 204, and various sensors 205.

The ROM 202 stores data and software (including firmware) for achieving the functions of the printer 112, and the CPU 201 reads and runs the necessary software and information from ROM 202 to achieve the printer functions. RAM 203 stores the data needed to achieve the functions of the printer 112. Sensors 205 such as error sensors, cover open sensors, and a near-end sensor are connected to the CPU 201 and input the respective detection results to the CPU 201.

The printing mechanism 204, which performs such physical operations as transporting the print medium, printing, and cutting the print medium, has a print head, one or more motors, and a printing control circuit for driving and controlling these operations.

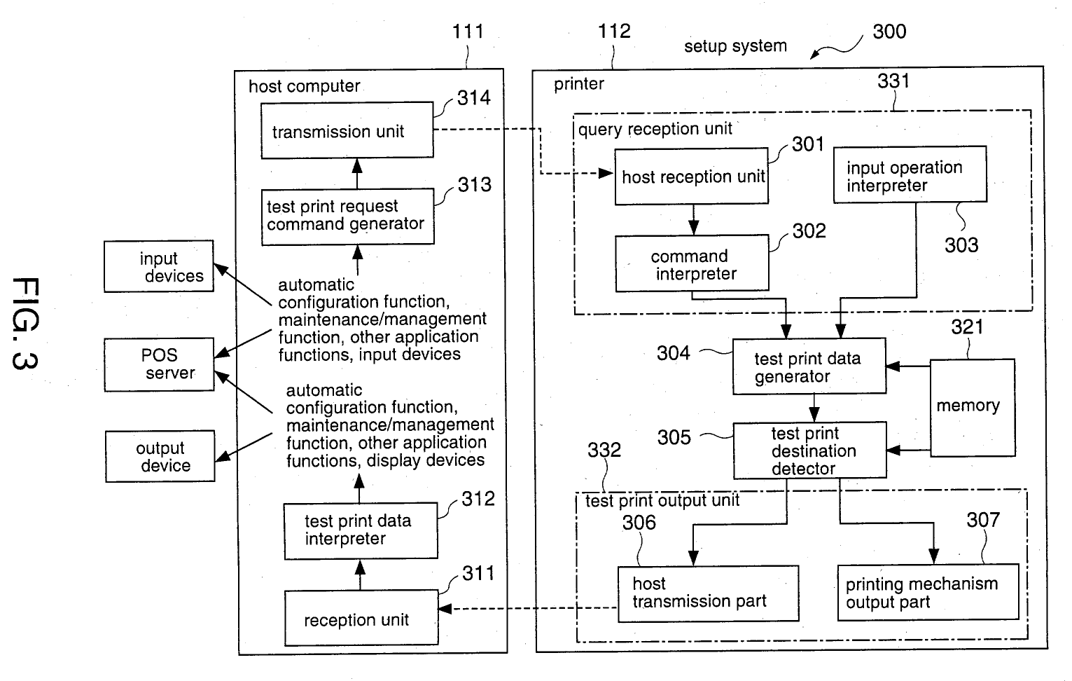

FIG. 3 is a function block diagram of a POS system setup system according to the present invention.

This setup system 300 is a system for configuring, or setting up, the printer 112 of the above-described POS terminal system 101 using the test printing function of the printer 112. The printer 112 has a query reception unit 331, test print data generator 304, test print destination detector 305, and test print output unit 332. The host computer 111 has a reception unit 311, test print data interpreter 312, test print request command generator 313, and transmission unit 314.

The query reception unit 331 of the printer 112 is a function for accepting a test print request to get the printer information, and includes a host reception unit 301, command interpreter 302, and input operation interpreter 303.

The host reception unit 301 of the printer 112 receives print data and commands from the host computer 111 through the communications interface 206. The command interpreter 302 of the printer 112 interprets signals received from the host computer 111 by the host reception unit 301 to determine the content of the received commands. More specifically, the command interpreter 302 determines if a received command is a test print request.

The input operation interpreter 303 of the printer 112 interprets instructions from operator input based on conditions input from the sensors and operation of the switches by the operator. In other words, whether an instruction asserted by user input is a test print request is determined from a combination of operations such as the number of times switches on the operating panel are pressed, whether the cover is open or closed, the combination of operating panel switches pressed, and other such conditions.

The test print data generator 304 of the printer 112 acquires information required for the test print data based on test print requests detected by the command interpreter 302 or input operation interpreter 303, and based on the acquired information generates test print data for printing to the print medium as a character string.

Types of information that might be printed as test print data include, for example, a printer profile for printing the firmware version, which might differ in each printer, operating switches and the resident character set; a rolling pattern printout for printing the resident character set, including alphanumeric characters, special symbols, and kanji, in a rolling pattern; and a maintenance data printout of various maintenance counters in the printer, including the number of auto-cutter operations and cumulative printing time. The types of information to be printed in the test print are acquired based on the types of information indicated by the test print requests received by the command interpreter 302 or input operation interpreter 303, and the types of information stored in memory 321 as preset test print conditions.

The test print destination detector 305 of the printer 112 determines the destination of the test print data generated by the test print data generator 304. That is, the test print destination detector 305 determines whether the test print data generated as a character string is output to the host computer 111, sent as a print request to the printing mechanism 204, or both output to the host computer 111 and sent as a print request to the printing mechanism 204. The output destination -and output order can be specified in the test print request received by the command interpreter 302 or input operation interpreter 303. They could also be specified according to the output destination and output order stored to memory 321 as preset test print conditions. It is also possible to determine the reception status of the specified destinations based on the output order, and determine the ultimate destination based on the determined reception states of the destinations.

For example, if the destination based on the output order is the host computer 111 but the host computer 111 is unable to receive, operation could proceed using the printing mechanism 204 as the destination, a standby state could be assumed until the host computer 111 can receive, or the send request to the host computer 111 could be ignored. Furthermore, if the destination based on the output order is the printing mechanism 204 but the printing mechanism 204 cannot print, operation could proceed using the host computer 111 as the destination, a standby state could be assumed until the printing mechanism 204 can print again, or the output request to the printing mechanism 204 could be ignored.

The test print output unit 332 of the printer 112 is a function for outputting test print data to the destination identified by the test print destination detector 305, and has a host transmission part 306 and printing mechanism output part 307.

When the test print destination detector 305 tells the host transmission part 306 to send the test print data to the host computer 111, the host transmission part 306 generates test print transmission data for sending the test print data to the host computer 111 from the test print data, and then sends the resulting test print transmission data to the host computer 111.

If the test print destination detector 305 instructs the printing mechanism output part 307 to print the test print data from the printing mechanism 204, the printing mechanism output part 307 sends a test print request to the printing mechanism 204.

The reception unit 311 of the host computer 111 receives and interprets the information sent from the printer 112 to determine what information was received. More specifically, it identifies the test print data in the received information.

The test print data interpreter 312 of the host computer 111 interprets the character string in the received test print data and finds the processing function requiring the interpreted test print data, generates the data passed to the processing function found based on the interpreted test print data, and reports the generated data to the processing function.

For example, by generating and sending transmission data to the display 113, the test print data can be displayed on the display 113 so that the operator can easily configure the printer 112. It is also possible to automatically optimally configure the printer 112 of the POS terminal system 101 based on the interpreted test print data. It is also possible to determine the operating condition of the printer based on the maintenance counters, including whether ink needs refilling or the paper supply needs replenishing. Yet further, a maintenance/management analysis function for analyzing and forecasting store operations based on the issued receipts can be achieved by the POS server analyzing the maintenance counters from all printers in the POS system.

When a query from any processing function to the printer 112 is a test print request, the test print request command generator 313 of the host computer 111 generates command transmission data for the test print request to the printer 112 based on the request conditions. For example, the request could be from a specific function of an application, such as an automatic printer configuration function, or the operator could issue the request through an input device.

The transmission unit 314 of the host computer 111 sends the command transmission data for the test print request generated by the test print request command generator 313 to the printer 112.

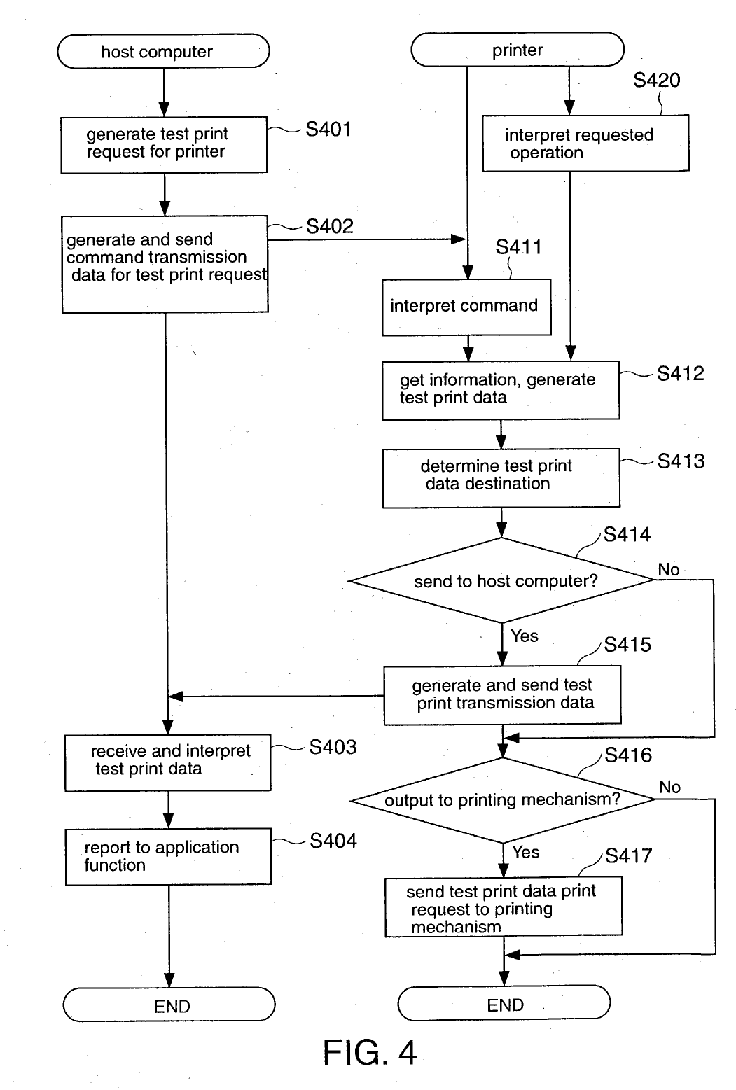

FIG. 4 is a flow chart showing the operation of the printer setup system.

Configuring the printer 112 in a POS terminal system 101 starts with a specific function of an application running on the host computer 111 issuing a test print request (S401) to get the printer settings and firmware version, for example, and generating and sending command transmission data for the test print request to the printer 112 (S402).

The printer 112 then receives the request command from the host computer 111 and interprets the command content (S411). If the command is a test print request, the printer 112 gets the data to be test printed, including the requested printer settings and firmware version, for example, based on the received command and any preset printing conditions data, and generates the test print data for test printing by the printing mechanism 204 of the printer 112 (S412). If the received command is not a test print request, the requested process is run.

The output destination for the generated test print data is then determined based on the received command and preset printing conditions (S413). That is, whether the generated test print data is returned to the host computer 111, printed by the printing mechanism 204, or both sent to the host computer 111 and printed by the printing mechanism 204, is determined.

Whether sending the test print data to the host computer 111 is required is then determined (S414). If it is (S414 returns yes), test print transmission data for sending the test print data to the host computer 111 is generated and sent (S415). If the test print data is not sent to the host computer 111 (S414 returns no), controls jumps to step S416.

The host computer 111 receives the test print data from the printer 112, interprets the test print data content (a character string) (S403), and passes the desired information in the interpreted test print data to the application function (S404) to configure the printer 112 of the POS terminal system 101. For example, by generating and sending data to the display 113, the test print data can be displayed on the display 113 so that the operator can easily configure the printer 112. It is also possible to automatically optimally configure the POS system printer 112 based on the interpreted test print data.

The printer 112 also determines if it is necessary to send the test print data to the printing mechanism 204 for printing (S416). If it is (S416 returns yes), a print request to print the test print data is asserted to the printing mechanism 204 (S417). The operator can then refer to the printed information and configure the printer 112.

However, if printing on the printing mechanism 204 is not requested (S416 returns no), the process ends.

It will be obvious that the above operating sequence can be reversed, that is, whether to output the test print data to the printing mechanism 204 can be decided before determining whether to send the test print data to the host computer 111.

The printer 112 can also receive test print requests as a result of a test print request asserted directly to the printer 112 (S420) rather than from the host computer 111. For example, a test print request could be asserted by the operator pressing one or more buttons or switches on the operating panel a certain number of times or some combination of buttons being operated in conjunction with a particular cover open state.

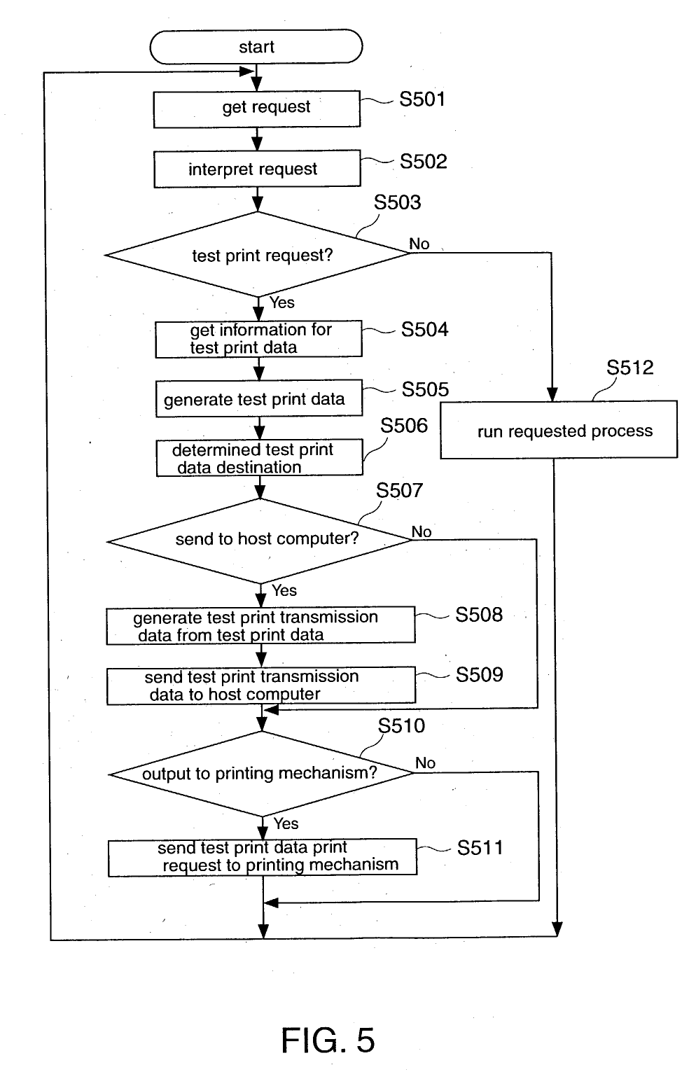

FIG. 5 is a flow chart of printer operation in a printer setup system.

The printer 112 first extracts request commands issued to the printer 112 (S501), interprets the content of the extracted request (S502), and determines if the request command is a test print request (S503). These command requests can be received as signals sent from the host computer 111 or by operating some specific printer controls. If the command request is not a test print request (S503 returns no), the process indicated by the command request is executed (S512), control then returns to step S501, and the printer waits for the next command.

If the command request is a test print request (S503 returns yes), the test print data is acquired based on the command request and preset printing conditions (S504). For example, the types of information available for test printing could include printer status information, a rolling pattern test print, and maintenance data.

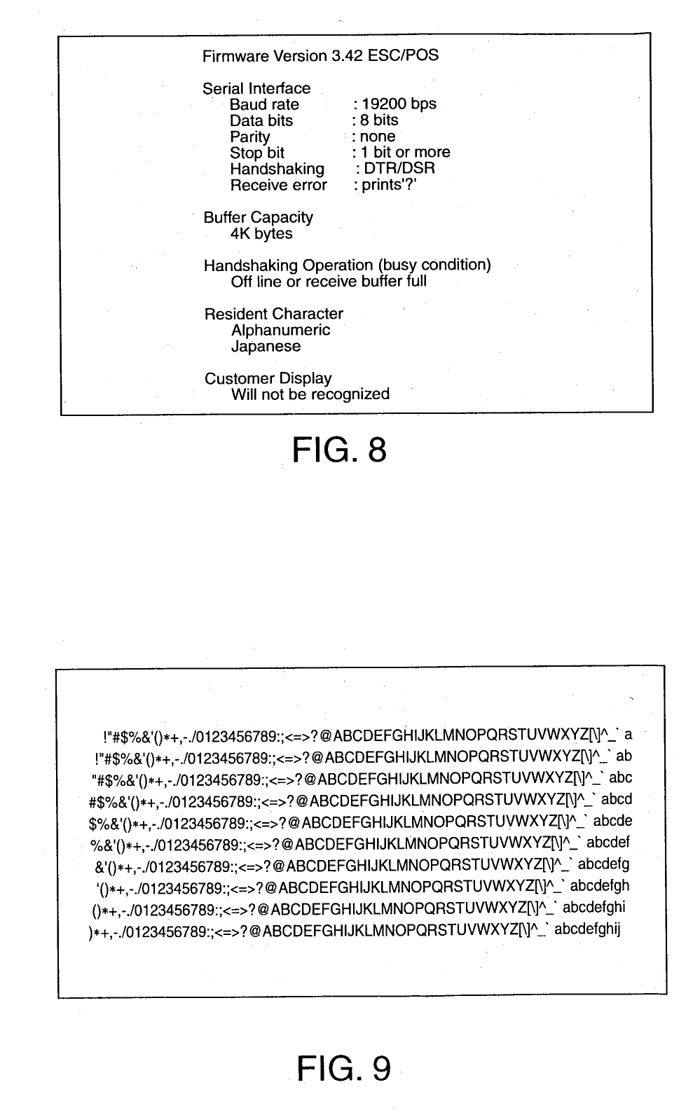

FIG. 8 shows a sample printout of printer status information. This status information here includes the firmware version, which may differ from printer to printer, configuration switches and their settings, and the resident character set.

FIG. 9 shows a sample printout of a rolling pattern test print. This rolling pattern print test prints the resident character set, including alphanumeric characters, symbols, and kanji, for example, in a rolling pattern.

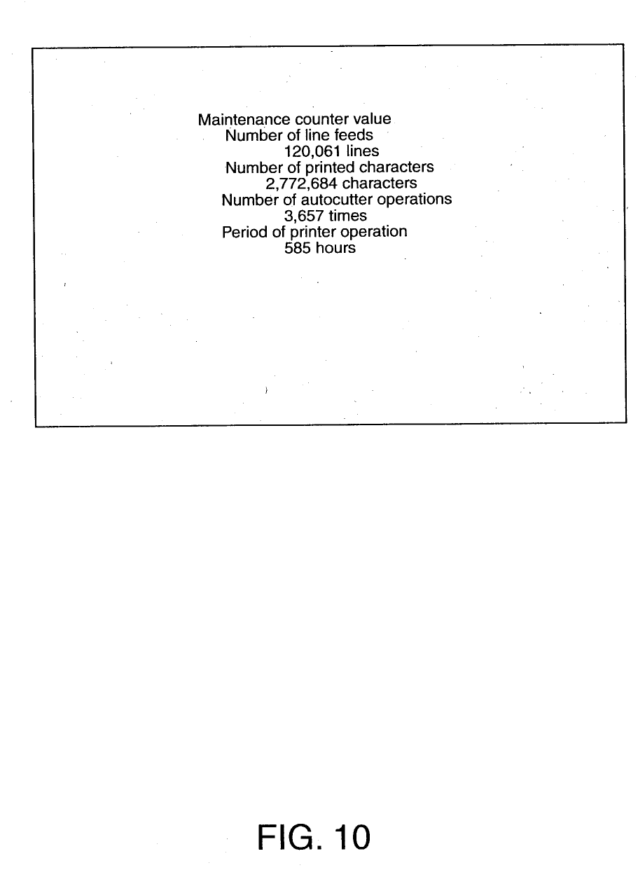

FIG. 10 shows a sample printout of maintenance data. The maintenance data printout shows the maintenance counters and their current values. In this example these include the number of autocutter operations and the cumulative printing time.

Based on the acquired information, the printer 112 generates test print data for printing by the printing mechanism 204 (S505). More specifically, the printer generates a character string for printing the test print data to paper.

The destination of the resulting test print data is then determined based on the received command and preset printing conditions (S506). More specifically, the printer determines whether to send the character string of test print data to the host computer 111, to the printing mechanism 204 for printing, or to both the host computer 111 and printing mechanism 204.

The output destination and the output order could also be specified as parameters in the received command. The order of the output destinations could also be preset and the destinations could be specified based on the output order. The reception status of the destinations could also be queried based on the output order, and the final destination could be determined based on whether the queried destination is able to receive.

The destination could be determined using the following command, for example.

ESC A n1 n2 n3 n4 n5

n1: type of paper

=1: roll paper

=2: slip form

n2: test print type

=1: printer status information

=2: rolling pattern

=3: maintenance data

n3: output destination priority

=1: printing mechanism

=2: host computer

=3: printing mechanism+host computer

n4: operation when host computer cannot receive (valid when n3=2 or 3)

=1: output to printing mechanism

=2: standby until host computer can receive

=3: ignore send requests to host computer

n5: operation when printing mechanism cannot print (valid when n3=1 or 3)

=1: output to host computer

=2: standby until printer can print

=3: ignore output requests to printing mechanism

Whether to send the test print data to the host computer 111 is then determined (S507). If the print data goes to the host computer (S507 returns yes), the printer generates the test print transmission data for sending the test print data to the host computer 111 (S508) and sends the test print transmission data to the host computer 111 (S509). If the data does not go to the host computer 111 (S507 returns no), control jumps to step S510.

Whether it is necessary to send a test print data print request to the printing mechanism 204 is then determined (S510). If the data goes to the printing mechanism 204 for printing (S510 returns yes), a test print request is asserted to the printing mechanism 204 (S511) and control then returns to step S501 to wait for the next command. If a print request is not sent to the printing mechanism 204 (S510 returns no), control returns to step S501 to wait for the next command.

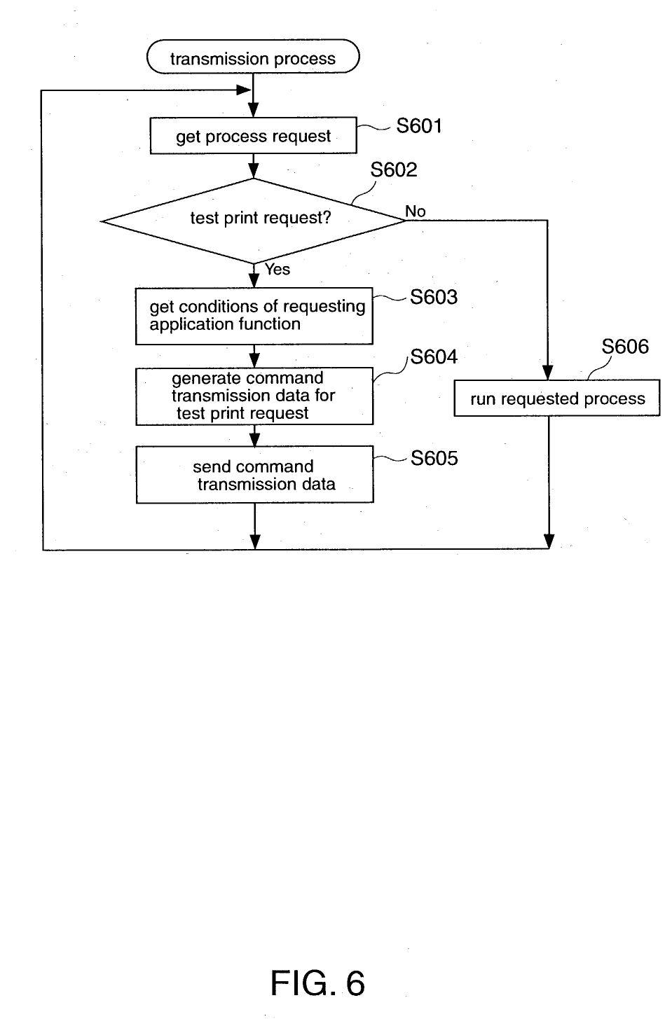

FIG. 6 is a flow chart showing a process whereby the host computer transmits to the printer in the setup system of the invention.

A host first gets a process request to the printer 112 (S601) and then determines if the process request is a test print request (S602). A test sprint request can be output by various functions. For example, a specific application function such as an automatic printer configuration process could issue a test print request, or the operator could input a test print request through some input device. If the process request is a test print request (S602 returns yes), the parameters of the function that issued the test print request are found (S603), and command transmission data for the test print request is generated based on the type of function and the parameters of the received test print request (S604).

The command transmission data for the test print request is then sent to the printer 112 (S605), control loops back to step S601, and the host waits for the next process request.

If the process request received by the host is not a test print request (S602 returns no), the process corresponding to the request is executed (S606), control then loops back to step S601, and the host waits for the next process request.

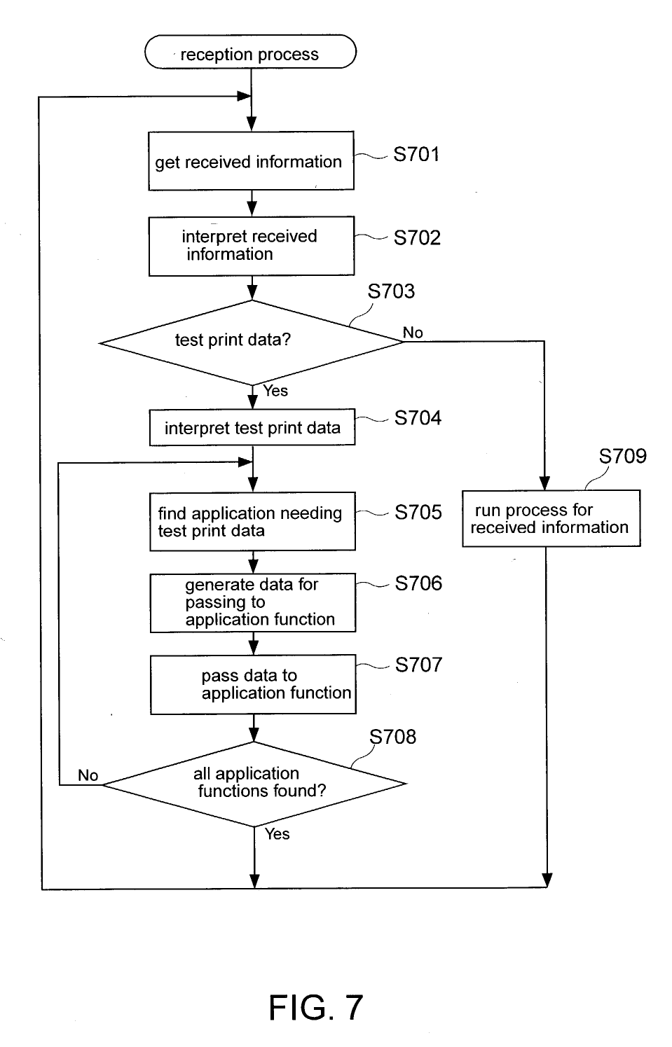

FIG. 7 is a flow chart showing how the host computer handles receiving from the printer in the setup system of the invention.

The host computer first receives signals from the printer 112 (S701), interprets the signals to determine what data was received (S702), and determines if test print data was received (S703). If the received data is not test print data (S703 returns no), a process appropriate to the received data is run (S709), control then returns to step S701, and the host waits until the next signals are received.

If test print data is received (S703 returns yes), the content of the test print data, which is a character string, is interpreted (S704). A process function needing the test print data is then found (S705), the data to be passed to the function is generated based on the interpreted test print data (S706) and passed to the function (S707) to configure the printer 112 of the POS terminal system 101.

For example, by generating and sending data to the display 113, the test print data can be displayed on the display 113 so that the operator can easily configure the printer 112. It is also possible to automatically optimally configure the POS system printer 112 based on the interpreted test print data. It is also possible to determine the operating condition of the printer based on the maintenance counters, including whether ink needs refilling or the paper supply needs replenishing. Yet further, a maintenance/management analysis function for analyzing and forecasting store operations based on the issued receipts can be achieved by the POS server analyzing the maintenance counters from all printers in the POS system.

Whether all process functions requiring the test print data were found or not is then determined (S708). If they were (S708 returns yes), control returns to step S701 and the host waits to receive the next data. If all process functions requiring the test print data have not been found (S708 returns no), control returns to step S705 and steps S705 to S708 repeat.

A data recording medium according to the present invention records a computer-executable program for executing the steps of the POS system setup methods described above. This data recording medium can be any computer-readable medium, including a Compact Disc, floppy disk, hard disk, magneto-optical disc, DVD, magnetic tape, or memory card.

[Effects of the Invention]

The invention described above provides the following benefits.

When configuring the settings required for a particular application function of a POS system, paper waste can be eliminated by sending printer information that can differ from printer to printer directly to the host computer and displaying it on a display device instead of printing the information as test print data on paper.

Operator error can also be removed by providing the host computer with a function for interpreting test print data containing the necessary printer information received from the printer, extracting the necessary information therefrom, and automatically configuring the required settings rather than having the operator manually enter configuration settings.

Furthermore, by enabling test print data containing the printer information to be output to the host computer and/or printing mechanism, setup is still possible when communication with the host computer is not possible or when the printer is unable to print by outputting the data using whichever function is able to output the data. Automatically configured settings can also be confirmed by the operator based on the printed test print data.

Furthermore, because all necessary printer information can be acquired with a test print request, the printer does not need a function for interpreting commands for each item of printer information. Printer firmware can therefore be simplified.

Furthermore, the host computer does not need a function for sending and interpreting commands for each item of printer information, and the setup function can be simplified.

Yet further, the condition of the printer can also be known by acquiring the values of the printer's maintenance counters as part of the test print data. Store operations can also be analyzed using the maintenance counter readings from all printers in the store.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

What is claimed is:

1. A POS system setup system for configuring a POS terminal system comprising:
a host computer; and
a printer characterized by printer-specific printer information, said printer comprising:
a) a printing mechanism;
b) a memory for storing operation conditions;
c) a request reception unit for receiving a test print request for said printer information;
d) a test print data generating unit for collecting the requested printer information based on the test print request received by the request reception unit, and generating test print data for printing the collected printer information;
e) a test print destination detection unit for determining whether to output the test print data, which is a character string, to the host computer and/or to the printing mechanism based on the test print request and/or operating conditions pre-stored in said memory; and
f) a test print data output unit for outputting the test print data to the host computer and/or printing mechanism as determined by the test print destination detection unit;
wherein the host computer comprises:
i) a reception unit for receiving the test print data from the test print data output unit; and
ii) a test print data interpreting unit for interpreting the character string in the test print data received by the reception unit, and for passing particular information in the interpreted test print data to a specific processing function of the host computer;
wherein the configuring of said POS terminal system includes setting said particular information for said specific processing function of the host computer based on said printer information.

2. The setup system of claim 1, wherein the host computer further comprises:
a test print request command generator for generating command transmission data for the test print request based on parameters received from the specific processing function when a process request from the specific processing function to the printer is a test print request; and
a transmission unit for sending the test print request including the command transmission data generated by the test print request command generator to the printer.

3. The setup system of claim 1, wherein the request reception unit of the printer comprises:
a host-request receiving unit for receiving print requests from the host computer;
a command interpreting unit for determining if a print request received by the host-request receiving unit is a test print request; and
an input operation interpreting unit for detecting test print requests from among preset print requests sent to the printer based on information input by means of an input device disposed to the printer and/or sensor status data.

4. The setup system of claim 1, wherein the test print data output unit comprises:
a host communication unit for generating test print transmission data for sending the test print data to the host computer, and sending the test print transmission data to the host computer; and
a printing mechanism output unit for sending a test print data print request to the printing mechanism.

5. The setup system of claim 1, wherein the test print destination detection unit comprises:
a function unit for determining, based on a reception readiness status of the host computer, whether the test print data should be output to the host computer even if it has already been determined that the test print data should be sent to the host computer, said function unit being further effective for determining, based on printing control of the printing mechanism, whether the test print data should be sent to the printing mechanism even if it has already been determined that the test print data should be output to the printing mechanism.

6. A POS system setup method for configuring a POS terminal system having a printer characterized by printer-specific printer information and having a host computer, said method comprising:
setting particular information for a specific processing function of the host computer based on said printer information, wherein:
the printer is effective for:
(a) receiving a test print request for acquiring the printer information from the printer;
(b) collecting the requested printer information based on the test print request received in step (a), and generating test print data for printing the collected printer information;
(c) determining whether to output the test print data, which is a character string, to the host computer and/or to the printing mechanism of the printer based on the test print request and/or conditions pre-stored in a memory; and
(d) outputting the test print data to the host computer and/or printing mechanism as determined in step (c); and
the host computer is effective for:
(i) receiving test print data from the printer; and
(ii) interpreting the character string in the test print data received in step (i), and passing particular information in the interpreted test print data to a specific processing function of the host computer for configuring the POS system.

7. The POS system setup method of claim 6, wherein the host computer is further effective for, before printer step (a):
generating command transmission data for the test print request based on parameters received from the specific processing function when a process request from the specific processing function to the printer is a test print request; and
sending the generated command transmission data to the printer.

8. The POS system setup method of claim 6, wherein step (a) of the printer comprises:
(a1) receiving print requests from the host computer;
(a2) determining if a print request received by the host-request receiving step is a test print request; and
(a3) detecting test print requests from among preset print requests sent to the printer based on information input by means of an input device coupled to the printer and/or sensor status data.

9. The POS system setup method of claim 6, wherein step (d) comprises:
(d1) generating test print transmission data for sending the test print data to the host computer, and sending the test print transmission data to the host computer; and
(d2) sending a test print data print request to the printing mechanism.

10. The POS system setup method of claim 6, wherein step (c) comprises:
(c1) determining, based on a reception readiness status of the host computer, whether the test print data should be output to the host computer even if it has already been determined that the test print data should be sent to the host computer, and/or determining, based on printing control of the printing mechanism, whether the test print data should be sent to the printing mechanism.

11. A program for executing the POS system setup method described in claim 6.

12. A computer-readable data storage medium for recording a program for executing the POS system setup method described in claim 6.
